(19) United States
(12) Patent Application Publication
(10) Pub. No.: US 2007/0120487 A1
(43) Pub. Date: May 31, 2007

(54) Plasma display panel

(75) Inventor: Sang Sub Ha, Busan (KR)

Correspondence Address: KED & ASSOCIATES, LLP, P.O. Box 221200, Chantilly, VA, 20153-1200, US

(73) Assignee: LG Electronics Inc.

(21) Appl. No.: 11/604,810

(22) Filed: Nov. 28, 2006

(30) Foreign Application Priority Data
Nov. 28, 2005 (KR) 10-2005-0114462

(51) Int. Cl. H01J 17/49

(52) U.S. Cl. 313/586

(57) ABSTRACT

A plasma display panel is disclosed. The plasma display panel includes a lower substrate including an alignment mark, and a dielectric layer positioned on an area where the alignment mark is excluded from an area of the lower substrate. The dielectric layer contains CuO.

This Nonprovisional application claims priority under 35 U.S.C. § 119(a) on Patent Application No. 10-2005-0114462 filed in Korea on Nov. 28, 2005 the entire contents of which are hereby incorporated by reference.

### BACKGROUND

1. Field

This document relates to a plasma display panel.

2. Description of the Related Art

A plasma display panel includes an upper panel and a lower panel. Each discharge cell formed between the upper panel and the lower panel is filled with a main discharge gas and an inert gas. When a high frequency voltage is supplied, the inert gas generates vacuum ultraviolet rays. The vacuum ultraviolet rays excite a phosphor such that light is emitted from the phosphor.

Since the plasma display panel includes the upper panel and the lower panel, a method of manufacturing the plasma display panel includes a process for coupling the upper panel and the lower panel.

The process for coupling the upper panel and the lower panel includes a process for aligning the upper panel and the lower panel and a process for coalescing the upper panel and the lower panel.

Since the alignment process of the upper panel and the lower panel greatly affects a performance of the plasma display panel, it is important to accurately perform the alignment process of the upper panel and the lower panel. When the alignment process is not accurately performed, the plasma display panel may not be operated smoothly.

### SUMMARY

In one aspect, a plasma display panel comprises a lower substrate including an alignment mark, and a dielectric layer positioned on an area where the alignment mark is excluded from an area of the lower substrate, wherein the dielectric layer contains CuO.

In another aspect, a plasma display panel comprises a lower substrate including an alignment mark, a lower dielectric layer positioned on an area where the alignment mark is excluded from an area of the lower substrate, an upper substrate coalesced with the lower substrate, an upper dielectric layer covering the upper substrate, and a seal layer positioned on the upper dielectric layer, wherein the lower dielectric layer contains CuO.

In still another aspect, a plasma display panel comprises a lower substrate including an alignment mark, and a dielectric layer positioned on an area where the alignment mark is excluded from an area of the lower substrate, wherein the dielectric layer contains CuO, and a content of CuO ranges from 0.1 wt % to 5 wt % based on total weight of a dielectric composition.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a plasma display panel according to first to third embodiments;

FIG. 2 illustrates a plasma display apparatus according to one embodiment;

FIG. 3 illustrates a driving signal of the plasma display apparatus according to one embodiment;

FIG. 4a is a plane view of the plasma display panel according to the first embodiment;

FIG. 4b is a cross-sectional view taken along a line S-S′ of FIG. 4a;

FIG. 5 is a plane view of the plasma display panel according to the second embodiment;

FIG. 6a is a plane view of the plasma display panel according to the third embodiment; and

FIG. 6b is a cross-sectional view taken along a line S-S′ of FIG. 6a.

### DETAILED DESCRIPTION OF PREFERRED EMBODIMENTS

Preferred embodiments of the present invention will be described in a more detailed manner with reference to the drawings.

A plasma display panel comprises a lower substrate including an alignment mark, and a dielectric layer positioned on an area where the alignment mark is excluded from an area of the lower substrate, wherein the dielectric layer contains CuO.

A content of CuO may range from 0.1 wt % to 5 wt % based on total weight of a dielectric composition.

A content of CuO may range from 0.2 wt % to 0.4 wt % based on total weight of the dielectric composition.

The lower substrate may include an effective area having a discharge cell from which light is emitted, and an ineffective area from which light is not emitted, and the alignment mark may be formed on the ineffective area.

The lower substrate may include an effective area having a discharge cell from which light is emitted, and an ineffective area from which light is not emitted. The dielectric layer may cover the effective area and a predetermined portion between the effective area and the alignment mark.

The dielectric layer may cover the effective area and the predetermined portion extending from the effective area toward the ineffective area by a distance of 0.8-1.0 mm.

The closest distance between a boundary line of the effective area and a boundary line of the dielectric layer may be substantially equal to the length of one side of a discharge cell.

The number of alignment marks may range from 2 to 8.

The two alignment marks may be positioned in a diagonal direction of the lower substrate.

The plasma display panel may further comprise a seal layer positioned on the ineffective area, wherein the alignment mark may be positioned between the dielectric layer formed on the effective area and the seal layer.

The dielectric layer may further contain PbO, B₂O₃, SiO₂, and Al₂O₃.

A content of PbO may range from 40 wt % to 70 wt %, a content of B₂O₃ may range from 3 wt % to 23 wt %, a content of SiO₂ may range from 1 wt % to 30 wt %, and a content of Al₂O₃ may range from 0.2 wt % to 8 wt %, based on total weight of a dielectric composition.

The dielectric layer may further contain TiO₂, and a content of TiO₂ may range from 0.2 wt % to 3 wt % based on total weight of the dielectric composition.

The lower substrate may include a plurality of alignment marks. The dielectric layer may be positioned on an area where at least two alignment marks of the plurality of alignment marks are excluded from an area of the lower substrate.

The plasma display panel may further comprise an upper substrate coalesced with the lower substrate, an upper dielectric layer covering the upper substrate, and a seal layer positioned on the upper dielectric layer.

The upper substrate, the seal layer, and the upper dielectric layer may have a first thermal expansion coefficient, a second thermal expansion coefficient, and a third thermal expansion coefficient, respectively. The first thermal expansion coefficient may be more than the second thermal expansion coefficient, and the third thermal expansion coefficient may be more than the second thermal expansion coefficient and less than the first thermal expansion coefficient.

The first thermal expansion coefficient may be about 87×10⁻⁷/° C., the second thermal expansion coefficient may be about 72×10⁻⁷/° C., and the third thermal expansion coefficient may be about 76×10⁻⁷/° C.

A plasma display panel comprises a lower substrate including an alignment mark, a lower dielectric layer positioned on an area where the alignment mark is excluded from the lower substrate, an upper substrate coalesced with the lower substrate, an upper dielectric layer covering the upper substrate, and a seal layer positioned on the upper dielectric layer, wherein the lower dielectric layer contains CuO.

The upper substrate, the seal layer, and the upper dielectric layer may have a first thermal expansion coefficient, a second thermal expansion coefficient, and a third thermal expansion coefficient, respectively. The first thermal expansion coefficient may be more than the second thermal expansion coefficient, and the third thermal expansion coefficient may be more than the second thermal expansion coefficient and less than the first thermal expansion coefficient.

A plasma display panel comprises a lower substrate including an alignment mark, and a dielectric layer positioned on an area where the alignment mark is excluded from the lower substrate, wherein the dielectric layer contains CuO, and a content of CuO ranges from 0.1 wt % to 5 wt % based on total weight of a dielectric composition.

Hereinafter, exemplary embodiments of the present invention will be described in detail with reference to the attached drawings.

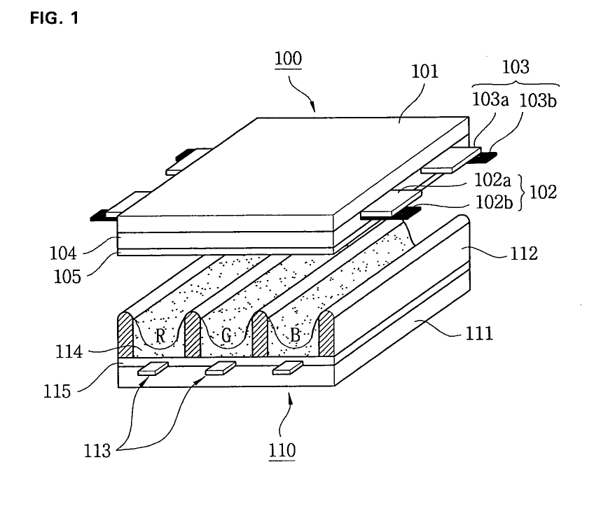

FIG. 1 illustrates a plasma display panel according to first to third embodiments. As illustrated in FIG. 1, the plasma display panel according to the first to third embodiments includes an upper panel 100 and a lower panel 110 which are coupled in parallel to oppose to each other at a given distance therebetween. The structure of the plasma display panel of FIG. 1 is commonly applied to the plasma display panel according to the first to third embodiments, and the plasma display panel according to the first to third embodiments will be described in detail later.

The upper panel 100 includes a scan electrode 102 for selecting a discharge cell to be discharged and maintaining light emission in the selected discharge cell, and a sustain electrode 103 for maintaining light emission in the selected discharge cell.

The scan electrode 102 and the sustain electrode 103 each include transparent electrodes 102a and 103a made of a transparent indium-tin-oxide (ITO) material and bus electrodes 102b and 103b made of a metal material. An upper dielectric layer 104 covering the scan electrode 102 and the sustain electrode 103 is formed on the scan electrode 102 and the sustain electrode 103. The upper dielectric layer 104 limits a discharge current and provides insulation between the scan electrode 102 and the sustain electrode 103. A protective layer 105 covering the upper dielectric layer 104 is formed on the upper dielectric layer 104. The protective layer 105 is formed using a deposition of magnesium oxide (MgO) to easily emit secondary electrons.

An address electrode 113 for selecting a discharge cell to be discharged is formed on a lower substrate 111 of the lower panel 110. A lower dielectric layer 115 covering the address electrode 113 is formed on the address electrode 113 to provide insulation of the address electrode 113 and to protect the address electrode 113. The lower dielectric layer 115 is made of a lower dielectric composition. The lower dielectric composition contains CuO. A content of CuO may range from 0.1 wt % to 5 wt %, or may range from 0.2 wt % to 0.4 wt %, based on total weight of the lower dielectric composition.

The lower dielectric layer 115 is formed by printing and then drying a dielectric paste being a paste of a lower dielectric powder on the lower substrate 111 of FIG. 1, and performing a high temperature firing process. CuO contained in the lower dielectric layer 115 reduces viscosity of the dielectric paste on the performance of the high temperature firing process. Therefore, CuO of the lower dielectric layer 115 accelerates the emission of bubbles generated inside the dielectric paste to the outside. When there is no bubble on the lower dielectric layer 115, a withstanding voltage of the lower dielectric layer 115 is secured stably. When the content of CuO ranges from 0.1 wt % to 5 wt % based on total weight of the lower dielectric composition, CuO reduces viscosity of the dielectric paste and also a reaction between CuO and another material decreases. When the content of CuO ranges from 0.2 wt % to 0.4 wt % based on total weight of the lower dielectric composition, CuO further reduces viscosity of the dielectric paste and also a reaction between CuO and another material further decreases.

The lower dielectric layer 115 contains PbO, B₂O₃, SiO₂, and Al₂O₃ in addition to CuO. A content of PbO ranges from 40 wt %. to 70 wt % based on total weight of the lower dielectric composition. When the content of PbO is within the above range, PbO lowers a softening point of a glass. B₂O₃, SiO₂ and Al₂O₃ stabilize the glass. A content of B₂O₃ may range from 3 wt % to 23 wt % based on total weight of the lower dielectric composition. A content of SiO₂ may range from 1 wt % to 30 wt % based on total weight of the lower dielectric composition. A content of Al₂O₃ may range from 0.2 wt % to 8 wt % based on total weight of the lower dielectric composition. The lower dielectric layer 115 may further include TiO₂. A content of TiO₂ may range from 0.2 wt % to 3 wt % based on total weight of the lower dielectric composition.

Ingredients of the lower dielectric layer 115 and contents of the ingredients except CuO may vary.

Barrier ribs 112 define discharge cells, and a phosphor 114 is positioned between the barrier ribs 112.

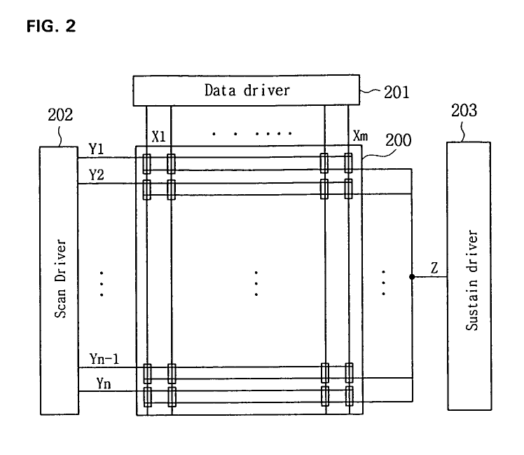

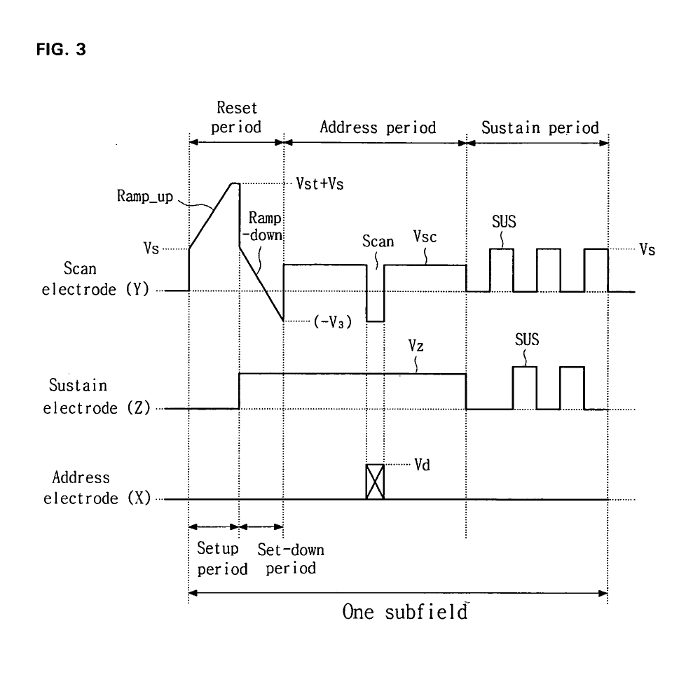

FIG. 2 illustrates a plasma display apparatus according to one embodiment. FIG. 3 illustrates a driving signal of the plasma display apparatus according to one embodiment. A scan electrode Y of FIG. 3 is one of a plurality of scan electrodes Y1 to Yn of FIG. 2. An address electrode X of FIG. 3 is one of a plurality of address electrodes X1 to Xm of FIG. 2. A sustain electrode Z of FIG. 3 is one of a plurality of sustain electrodes Z of FIG. 2.

The plasma display apparatus according to one embodiment includes a plasma display panel 200, a data driver 201, a scan driver 202, and a sustain driver 203. The plasma display panel 200 has described in detail with reference to FIG. 1, and thus a description thereof is omitted.

The scan driver 202 of FIG. 2 supplies a setup signal (Ramp-up) to the scan electrode Y during a setup period of a reset period of FIG. 3. The setup signal (Ramp-up) gradually rises from a first voltage Vs to a second voltage (Vs+Vst).

The setup signal (Ramp-up) generates a dark discharge inside all the discharge cells of the plasma display panel 200. This results in wall charges of a positive polarity being accumulated on the address electrode X and the sustain electrode Z and wall charges of a negative polarity being accumulated on the scan electrode Y.

The scan driver 202 supplies a set-down signal (Ramp-down) to the scan electrode Y during a set-down period of the reset period of FIG. 3. The set-down signal (Ramp-down) gradually falls from the first voltage Vs to a third voltage −V3. Thus, an erase discharge occur inside all the discharge cells such that a predetermined amount of wall charges excessively accumulated inside all the discharge cells is erased. The remaining wall charges inside all the discharge cells are uniform.

The scan driver 202 supplies a scan signal (Scan) to the scan electrode Y during an address period of FIG. 3. The data driver 201 supplies a data signal corresponding to a video signal to the address electrode X in synchronization of the scan signal (Scan). The highest voltage of the data signal is equal to Vd. Discharge cells to emit light during a sustain period are selected during the address period.

During the sustain period, the scan driver 202 and the sustain driver 203 alternately supply sustain signals (SUS) to the scan electrode Y and the sustain electrode Z. Thus, as a wall voltage inside the discharge cells selected during the address period is added to the sustain signal (SUS), a sustain discharge occur between the scan electrode Y and the sustain electrode Z.

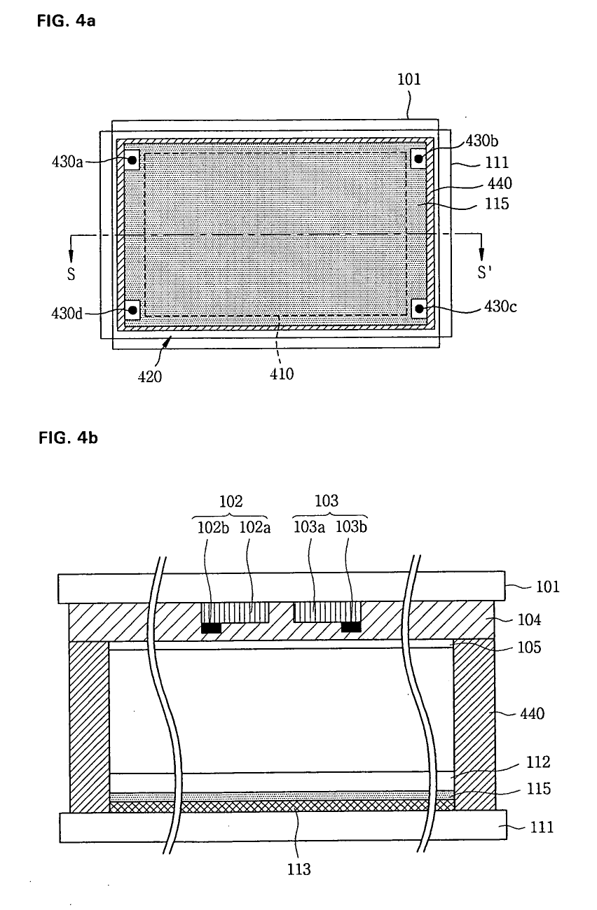

FIG. 4a is a plane view of the plasma display panel according to the first embodiment. FIG. 4b is a cross-sectional view taken along a line S-S′ of FIG. 4a.

An upper substrate 101 and the lower substrate 111 of the plasma display panel according to the first embodiment are coalesced with each other at a given distance therebetween. The lower substrate 111 includes an effective area 410 having the discharge cells from which light is emitted, and an ineffective area 420 from which light is not emitted. The ineffective area 420 protects the effective area 410. The ineffective area 420 is an area where the effective area 410 is excluded from an overlap area of the upper substrate 101 and the lower substrate

The lower dielectric layer 115 on the lower substrate 111 is partially positioned on the effective area 410 and the ineffective area 420 of the lower substrate 111. Alignment marks 430a, 430b, 430c and 430d are positioned on the lower substrate 111. The alignment marks 430a, 430b, 430c and 430d may be positioned on the ineffective area 420 of the lower substrate 111. The alignment marks 430a, 430b, 430c and 430d are used to align the upper substrate 101 and the lower substrate 111 when coalescing the upper substrate 101 and the lower substrate 111. The alignment marks 430a, 430b, 430c and 430d may be formed on the upper substrate 101 as well as the lower substrate 111.

The lower dielectric layer 115 containing CuO is formed on an area where the alignment marks 430a, 430b, 430c and 430d are excluded from the lower substrate 111. For example, the lower dielectric layer 115 may cover the effective area 410 of the lower substrate 111 and an area where the alignment marks 430a, 430b, 430c and 430d are excluded from the ineffective area 420 of the lower substrate 111.

Since the lower dielectric layer 115 contains CuO, transparency of the lower dielectric layer 115 decreases. If the lower dielectric layer 115 is positioned on the alignment marks 430a, 430b, 430c and 430d, it is difficult that a CCD camera (not illustrated) of an alignment equipment forms images of the alignment marks. Therefore, the coalescence accuracy of the upper substrate and the lower substrate 111 decreases. Accordingly, the lower dielectric layer 115 according to one embodiments covers the area where the alignment marks 430a, 430b, 430c and 430d are excluded from the lower substrate 111.

As above, when the lower dielectric layer 115 according to one embodiments covers the area where the alignment marks 430a, 430b, 430c and 430d are excluded from the lower substrate 111, the coalescence accuracy of the upper substrate and the lower substrate 111 increases and time required to coalesce the upper substrate and the lower substrate 111 is reduced.

The alignment marks 430a, 430b, 430c and 430d illustrated in FIGS. 4a and 4b may be positioned between a seal layer 440 and the effective area 410. The seal layer 440 is used to coalesce the upper substrate 101 and the lower substrate 111, and to isolate the discharge cells formed inside the plasma display panel from the outside.

The upper dielectric layer 104 is formed between the upper substrate 101 and the seal layer 440 to reduce thermal stress between the upper substrate 101 and the seal layer 440. The upper substrate 101 has a first thermal expansion coefficient, the seal layer 440 has a second thermal expansion coefficient that is less than the first thermal expansion coefficient, and the upper dielectric layer 104 has a third thermal expansion coefficient between the first and second thermal expansion coefficients. For example, a thermal expansion coefficient of the upper substrate 101 is about 87×10⁻⁷/° C., a thermal expansion coefficient of the seal layer 440 is about 72×10⁻⁷/° C., and a thermal expansion coefficient of the upper dielectric layer 104 is about 76×10⁻⁷/° C.

When the protective layer 105 is formed in an atmosphere of about 200-300° C. and then the upper substrate 101 is cooled at a room temperature, the upper dielectric layer 104 distributes the thermal stress caused by a difference between the thermal expansion coefficients of the upper substrate 101 and the seal layer 440. Since the upper dielectric layer 104 distributes the thermal stress, a crack generated in an area of the upper substrate 101, that overlaps the seal layer 440 with the upper dielectric layer 104 being interposed therebetween, is prevented. The upper dielectric layer 104 contains PbO of 50 wt %, B₂O₃ of 15 wt %, Al₂O₃ of 15 wt %, and SiO₂ of 20 wt % based on total weight of a upper dielectric composition.

Although FIG. 4a has illustrated the four alignment marks 430a, 430b, 430c and 430d positioned on the lower substrate 111, at least two alignment marks may be positioned on the lower substrate 111. For example, if 2-8 alignment marks are positioned on the lower substrate 111, the upper substrate 101 and the lower substrate 111 are accurately coalesced in a short period of time.

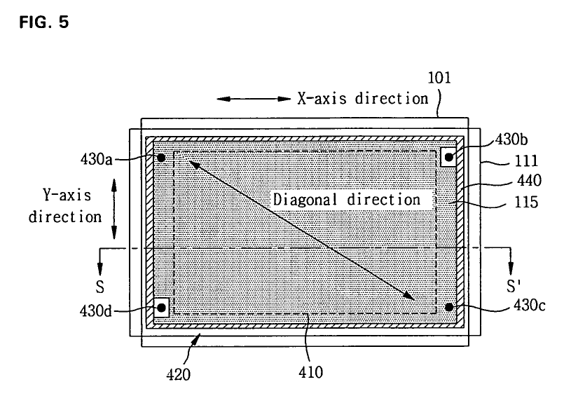

FIG. 5 is a plane view of the plasma display panel according to the second embodiment. As illustrated in FIG. 5, although the lower dielectric layer 115 covers the remaining alignment marks 430a and 430c except two alignment marks 430b and 430d positioned in a diagonal direction of the lower substrate 111 in the plurality of alignment marks 430a, 430b, 430c and 430d, the upper substrate 101 and the lower substrate 111 are coalesced accurately. Even if the lower dielectric layer 115 covers the remaining alignment marks except two alignment marks positioned in an X-axis direction or an Y-axis direction in addition to the diagonal direction illustrated in FIG. 5, the upper substrate 101 and the lower substrate 111 are coalesced accurately.

A cross-sectional view taken along a line S-S′ of FIG. 5 is the same as the cross-sectional view of the plasma display panel illustrated in FIG. 4b, and thus a description thereof is omitted.

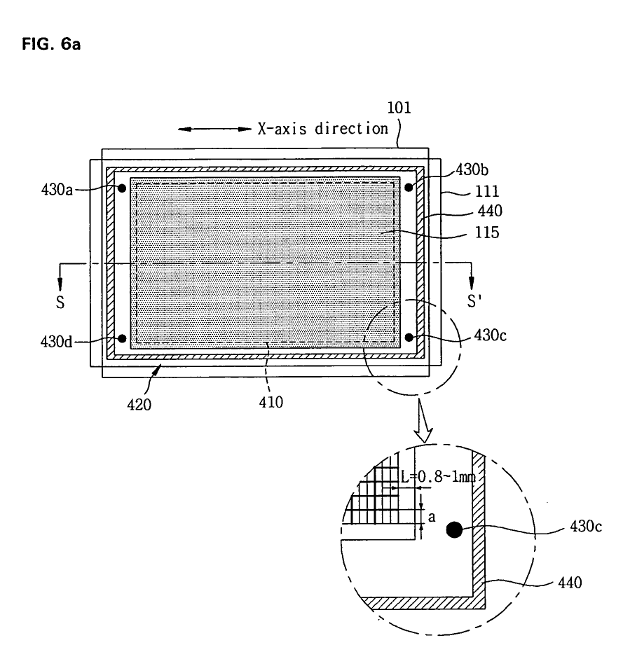

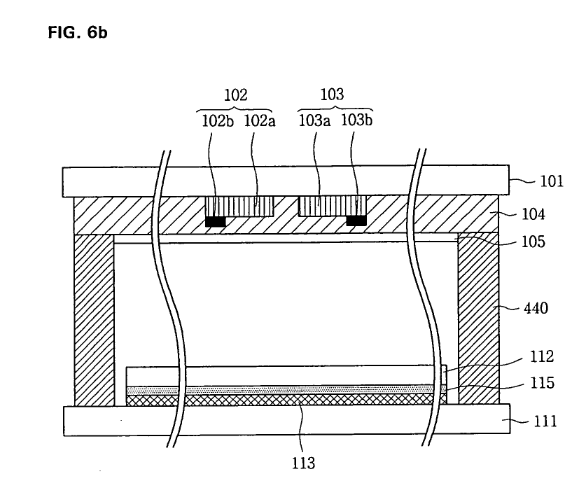

FIG. 6a is a plane view of the plasma display panel according to the third embodiment. FIG. 6b is a cross-sectional view taken along a line S-S′ of FIG. 6a.

As illustrated in FIG. 6a, the lower dielectric layer 115 of the plasma display panel according to the third embodiment covers an effective area 410 and a predetermined portion between the effective area 410 and alignment marks 430a, 430b, 430c and 430d. Therefore, the area of the lower dielectric layer 115 according to the third embodiment is less than the area of the lower dielectric layer 115 according to the first embodiment.

Since the lower dielectric layer 115 does not cover the alignment marks 430a, 430b, 430c and 430d, the upper substrate 101 and the lower substrate 111 are coalesced accurately and rapidly and the amount of a lower dielectric composition forming the lower dielectric layer 115 decreases.

The predetermined portion between the effective area 410 and the alignment marks 430a, 430b, 430c and 430d may extend from the effective area 410 toward the ineffective area 420 by a distance of 0.8-1.0 mm. A reason to set the predetermined portion to the above range is that the length of one side “a” of a discharge cell ranges from 0.8 mm to 1.0 mm. In other words, the closest distance L between a boundary line of the effective area 410 and a boundary line of the lower dielectric layer 115 is substantially equal to the length of one side “a” of a discharge cell. Thus, when the lower dielectric layer 115 covers the effective area 410 and the predetermined portion, the dielectric amount is reduced while the lower dielectric layer 115 sufficiently covers the effective area 410.

The alignment marks 430a, 430b, 430c and 430d illustrated in FIGS. 6a and 6b may be positioned between a seal layer 440 and the effective area 410. The seal layer 440 is used to coalesce the upper substrate 101 and the lower substrate 111, and to isolate the discharge cells formed inside the plasma display panel from the outside.

The description of components except the lower dielectric layer 115 illustrated in FIG. 6b have described in FIG. 4, the description are omitted.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel, comprising:
a lower substrate including an alignment mark; and
a dielectric layer positioned on an area where the alignment mark is excluded from a area of the lower substrate,
wherein the dielectric layer contains CuO.

2. The plasma display panel of claim 1, wherein a content of CuO ranges from 0.1 wt % to 5 wt % based on total weight of a dielectric composition.

3. The plasma display panel of claim 2, wherein a content of CuO ranges from 0.2 wt % to 0.4 wt % based on total weight of the dielectric composition.

4. The plasma display panel of claim 1, wherein the lower substrate includes an effective area having a discharge cell from which light is emitted, and an ineffective area from which light is not emitted, and
the alignment mark is formed on the ineffective area.

5. The plasma display panel of claim 1, wherein the lower substrate includes an effective area having a discharge cell from which light is emitted, and an ineffective area from which light is not emitted, and
the dielectric layer covers the effective area and a predetermined portion between the effective area and the alignment mark.

6. The plasma display panel of claim 5, wherein the dielectric layer covers the effective area and the predetermined portion extending from the effective area toward the ineffective area by a distance of 0.8-1.0 mm.

7. The plasma display panel of claim 5, wherein the closest distance between a boundary line of the effective area and a boundary line of the dielectric layer is substantially equal to the length of one side of a discharge cell.

8. The plasma display panel of claim 1, wherein the number of alignment marks ranges from 2 to 8.

9. The plasma display panel of claim 8, wherein the two alignment marks are positioned in a diagonal direction of the lower substrate.

10. The plasma display panel of claim 5, further comprising a seal layer positioned on the ineffective area,
wherein the alignment mark is positioned between the dielectric layer formed on the effective area and the seal layer.

11. The plasma display panel of claim 1, wherein the dielectric layer further contains PbO, B₂O₃, SiO₂, and Al₂O₃.

12. The plasma display panel of claim 11, wherein a content of PbO ranges from 40 wt % to 70 wt %, a content of B₂O₃ ranges from 3 wt % to 23 wt %, a content of SiO₂ ranges from 1 wt % to 30 wt %, and a content of Al₂O₃ ranges from 0.2 wt % to 8 wt %, based on total weight of a dielectric composition.

13. The plasma display panel of claim 12, wherein the dielectric layer further contains TiO₂, and
a content of TiO₂ ranges from 0.2 wt % to 3 wt % based on total weight of the dielectric composition.

14. The plasma display panel of claim 1, wherein the lower substrate includes a plurality of alignment marks, and
the dielectric layer is positioned on an area where at least two alignment marks of the plurality of alignment marks are excluded from a area of the lower substrate.

15. The plasma display panel of claim 1, further comprising an upper substrate coalesced with the lower substrate, an upper dielectric layer covering the upper substrate, and a seal layer positioned on the upper dielectric layer.

16. The plasma display panel of claim 15, wherein the upper substrate, the seal layer, and the upper dielectric layer have a first thermal expansion coefficient, a second thermal expansion coefficient, and a third thermal expansion coefficient, respectively, and
the first thermal expansion coefficient is more than the second thermal expansion coefficient, and the third thermal expansion coefficient is more than the second thermal expansion coefficient and less than the first thermal expansion coefficient.

17. The plasma display panel of claim 16, wherein the first thermal expansion coefficient is about 87×10⁻⁷/° C., the second thermal expansion coefficient is about 72×10⁻⁷/° C., and the third thermal expansion coefficient is about 76×10⁻⁷/° C.

18. A plasma display panel, comprising:
a lower substrate including an alignment mark;
a lower dielectric layer positioned on an area where the alignment mark is excluded from an area of the lower substrate;
an upper substrate coalesced with the lower substrate;
an upper dielectric layer covering the upper substrate; and
a seal layer positioned on the upper dielectric layer,
wherein the lower dielectric layer contains CuO.

19. The plasma display panel of claim 18, wherein the upper substrate, the seal layer, and the upper dielectric layer have a first thermal expansion coefficient, a second thermal expansion coefficient, and a third thermal expansion coefficient, respectively, and
the first thermal expansion coefficient is more than the second thermal expansion coefficient, and the third thermal expansion coefficient is more than the second thermal expansion coefficient and less than the first thermal expansion coefficient.

20. A plasma display panel, comprising:
a lower substrate including an alignment mark; and
a dielectric layer positioned on an area where the alignment mark is excluded from an area of the lower substrate,
wherein the dielectric layer contains CuO, and a content of CuO ranges from 0.1 wt % to 5 wt % based on total weight of a dielectric composition.
